(19) United States
(12) Patent Application Publication
(10) Pub. No.: US 2008/0207262 A1
(43) Pub. Date: Aug. 28, 2008

(54) PORTABLE TERMINAL APPARATUS

(75) Inventors: Noritaka SHIMIZU, Kanagawa (JP); Toshikazu MITSUTAKE, Kanagawa (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 12/037,440

(22) Filed: Feb. 26, 2008

(30) Foreign Application Priority Data
Feb. 28, 2007 (JP) 2007-050489

(51) Int. Cl. H04M 1/00

(52) U.S. Cl. 455/556.1

(57) ABSTRACT

A portable terminal apparatus is provided that enables a mobile TV reception function to be added easily even to a main CPU that does not have a dedicated mobile TV interface. There are provided a cellular baseband LSI 110 that performs overall control of a portable terminal apparatus 100 and is also connected to a mobile TV back-end processing LSI 120 by a host I/F 141, camera I/F 142, and audio I/F 143, and a mobile TV back-end processing LSI 120 that implements a mobile TV function, wherein mobile TV back-end processing LSI 120 includes a selection circuit 122 that selects a video signal from a mobile phone camera module 125 or a mobile TV video signal based on a control signal from cellular baseband LSI 110, and outputs one or other video signal to camera I/F 142.

### CROSS REFERENCE TO RELATED APPLICATIONS

The disclosure of Japanese Patent Application No. 2007-050489 filed on Feb. 28, 2007 including the specification, drawings and abstract is incorporated herein by reference in its entirety.

### BACKGROUND OF THE INVENTION

1. Field of the Invention

The present invention relates to a communication terminal apparatus such as a camera-equipped mobile phone.

2. Description of the Related Art

In recent years, with the development of small, low-power-consumption image sensors, it has become possible to incorporate a camera in portable apparatuses such as PDAs (Personal Digital Assistants) and mobile phones, and images captured by a built-in camera, such as photographs of printed documents used instead of memos, can be transmitted immediately by e-mail.

In Patent Document 1 (Unexamined Japanese Patent Publication No. 2004-64350), there is described an imaging-apparatus-equipped mobile phone used for different purposes, provided with a plurality of imaging apparatuses with different specifications and a selection section that selects one of these imaging apparatuses.

Also, mobile phones equipped with a function for receiving mobile TV broadcast signals is configured by means of a mobile TV receiving module comprising an RF section and baseband section, a main CPU that performs AV decoding processing and back-end processing for processing data broadcasts, and so forth, each connected by means of a dedicated interface. For example, the main CPU is equipped with a dedicated mobile TV reception interface for receiving a video service in which a data broadcast and AV stream are multiplexed, as in the case of an application LSI. Also, in the car navigation service described in Patent Document 2 (National Publication of International Patent Application No. 2005-509166), a mobile TV reception system is disclosed in which dedicated interfaces that output MPEG2-TS (Moving Picture Experts Group 2—Transport Stream) such as ISDB-T (Integrated Services Digital Broadcasting—Terrestrial) and DVB-H (Digital Video Broadcast for Handhelds) receiving modules are provided as mobile TV reception modules, and mutually connected.

However, with such camera-equipped portable terminal apparatuses, a main CPU having a camera interface is used in most mobile phones. On the other hand, as regards ISDB-T, T-DMB, and DVB-H mobile TV reception functions, service has only just begun, and in many cases the main CPU does not have a dedicated mobile TV interface. Furthermore, manufacturers developing small portable apparatuses including mobile TV terminals such as conventional mobile phones have little experience of developing TV viewing and recording functions, and development of programs enabling such functions to be implemented is difficult.

### SUMMARY OF THE INVENTION

It is an object of the present invention to provide a portable terminal apparatus that enables a mobile TV reception function to be added easily even to a main CPU that does not have a dedicated mobile TV interface.

According to an aspect of the invention, a portable terminal apparatus is equipped with an external specific function section that executes a specific program, a host interface that controls the external specific function section, a camera interface, and a control section that performs control for selecting output from the external specific function section or input to the camera interface, and connecting that selected signal to the camera interface.

### BRIEF DESCRIPTION OF THE DRAWINGS

FIG. 1 is a block diagram showing the general configuration of a portable terminal apparatus of Embodiment 1 of the present invention;

FIG. 2 is a block diagram showing the configuration of a mobile TV system incorporated in a portable terminal apparatus of above Embodiment 1;

FIG. 3 is a block diagram showing the configuration of a mobile TV back-end LSI of a portable terminal apparatus of above Embodiment 1;

FIG. 4 is a block diagram showing the general configuration of a portable terminal apparatus of Embodiment 2 of the present invention;

FIG. 5 is a block diagram showing the general configuration of a portable terminal apparatus of Embodiment 3 of the present invention;

FIG. 6 is a drawing showing an example of combining of camera video inputs by a combining block of a portable terminal apparatus of above Embodiment 3;

FIG. 7 is a block diagram showing the general configuration of a portable terminal apparatus of Embodiment 4 of the present invention;

FIG. 8 is a block diagram showing the general configuration of a portable terminal apparatus of Embodiment 5 of the present invention; and

FIG. 9 is a block diagram showing the general configuration of a portable terminal apparatus of Embodiment 6 of the present invention.

### DETAILED DESCRIPTION OF THE PREFERRED EMBODIMENTS

With reference now to the accompanying drawings, embodiments of the present invention will be explained in detail below.

### Embodiment 1

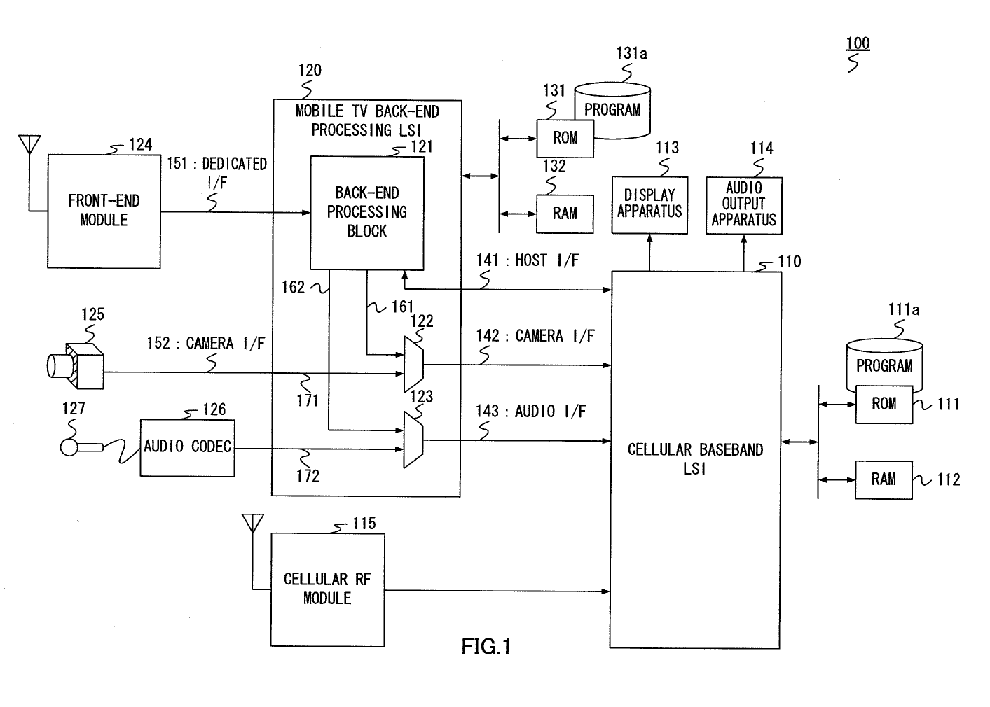

FIG. 1 is a block diagram showing the general configuration of a portable terminal apparatus of Embodiment 1 of the present invention. A portable terminal apparatus of this embodiment is an example in which a mobile TV system is applied to a camera-equipped mobile phone/PHS (Personal Handy-Phone System).

In FIG. 1, a portable terminal apparatus 100 is configured by means of a cellular baseband LSI 110, ROM 111 that has a control program 111a, RAM 112, a display apparatus 113, an audio output apparatus 114, a cellular RF module 115, a mobile TV back-end processing LSI 120, a back-end processing block 121, selection circuits 122 and 123, a front-end module 124, a mobile phone camera module 125, an audio codec 126, a microphone 127, ROM 131 that has a control program 131a, RAM 132, a host interface (I/F) 141, camera interfaces (I/Fs) 142 and 152, an audio interface (I/F) 143, and a dedicated interface (I/F) 151. Although not shown in the figure, portable terminal apparatus 100 is also equipped with a key input apparatus for inputting data by means of user operations, comprising phone function keys, arrow keys, mode keys, dial keys, and the like, a speaker, and so forth.

Cellular baseband LSI 110, comprising a CPU and so forth, performs overall control of portable terminal apparatus 100, and is also connected to mobile TV back-end processing LSI 120 by host I/F 141, camera I/F 142, and audio I/F 143, and has a mobile TV reception function through combined use of camera I/F 142 that inputs a video signal from mobile phone camera module 125 as a mobile TV viewing video signal input I/F.

ROM 111 is read-only semiconductor memory that stores control program 111a, communication control data and other fixed data, and so forth, required for operation of portable terminal apparatus 100. RAM 112 is used as so-called working memory that temporarily stores display and communication related data, data used in computations, computation results, and so forth. A program processed by portable terminal apparatus 100 is executed after being placed in this RAM. Part of the RAM comprises electrically rewritable nonvolatile memory known as EEPROM (electrically erasable programmable ROM), and various portable terminal apparatus 100 specifications, in particular, can be changed by modifying a program written in the EEPROM.

Display apparatus 113 is configured by means of an LCD display capable of dot matrix color display, EL (Electro Luminescence), a white LED backlight, drivers, and so forth, and performs color display of received information and information such as image, text information, and the like. Audio output apparatus 114 comprises an amplifier, speaker, and so forth that output an audio signal. Cellular RF module 115 controls portable terminal apparatus 100 radio communication transmission and reception.

Mobile TV back-end processing LSI 120 includes back-end processing block 121, selection circuit 122, and selection circuit 123, and executes mobile TV reception front-end processing.

Back-end processing block 121 performs AV separation and decoding of an MPEG2-TS (Moving Picture Experts Group 2—Transport Stream) format bit stream input from front-end module 124, and outputs a video signal 161 and audio signal 162 to selection circuit 122 and selection circuit 123 respectively.

Selection circuit 122 selects video signal 161 output from back-end processing block 121 or a video signal 171 input from camera I/F 152 connected to mobile phone camera module 125.

Selection circuit 123 selects audio signal 162 output from back-end processing block 121 or an audio signal 172 output from audio codec 126.

A pair of AV digital signals are selected by above-described selection circuit 122 and selection circuit 123, and are input to cellular baseband LSI 110 via camera I/F 142 and audio I/F 143.

Front-end module 124 executes mobile TV reception front-end processing. Front-end module 124 is connected to mobile TV back-end processing LSI 120 via dedicated I/F 151.

Mobile phone camera module 125 is, for example, a 2-megapixel CCD (Charge Coupled Device) camera incorporated in portable terminal apparatus 100. This camera has a fixed focal length lens, and its depth of field is switched for normal imaging and bar code reading. This camera also has a zoom function.

Audio codec 126, comprising a voice synthesis LSI, performs digital signal processing of audio data input from microphone 127, and inputs audio signal 172 that has undergone digital signal processing to one input terminal of selection circuit 123.

ROM 131 stores control program 113a, communication control data and other fixed data, and so forth, required for operation of mobile TV back-end processing LSI 120. RAM 132 temporarily stores data used in mobile TV back-end processing LSI 120 computations, computation results, and so forth.

Host I/F 141 conveys commands and data broadcasts for control of back-end processing block 121 of mobile TV back-end processing LSI 120 by cellular baseband LSI 110.

Camera I/F 142 inputs video signal 161 selected by selection circuit 122 of mobile TV back-end processing LSI 120 to cellular baseband LSI 110.

Audio I/F 143 inputs audio signal 172 output from audio codec 126 to cellular baseband LSI 110 via mobile TV back-end processing LSI 120.

Dedicated I/F 151 connects front-end module 124 to mobile TV back-end processing LSI 120, and transmits and receives MPEG2-TS format bit-stream data.

Camera I/F 152 inputs video signal 171 output from mobile phone camera module 125 to mobile TV back-end processing LSI 120.

A feature of this embodiment is that mobile TV back-end processing LSI 120 is equipped with selection circuit 123, and video signal 171 output from mobile phone camera module 125 is not input directly to camera I/F 142 of cellular baseband LSI 110, but first passes through selection circuit 123 of mobile TV back-end processing LSI 120, and is input to mobile TV back-end processing LSI 120 as a selection circuit 123 selection result.

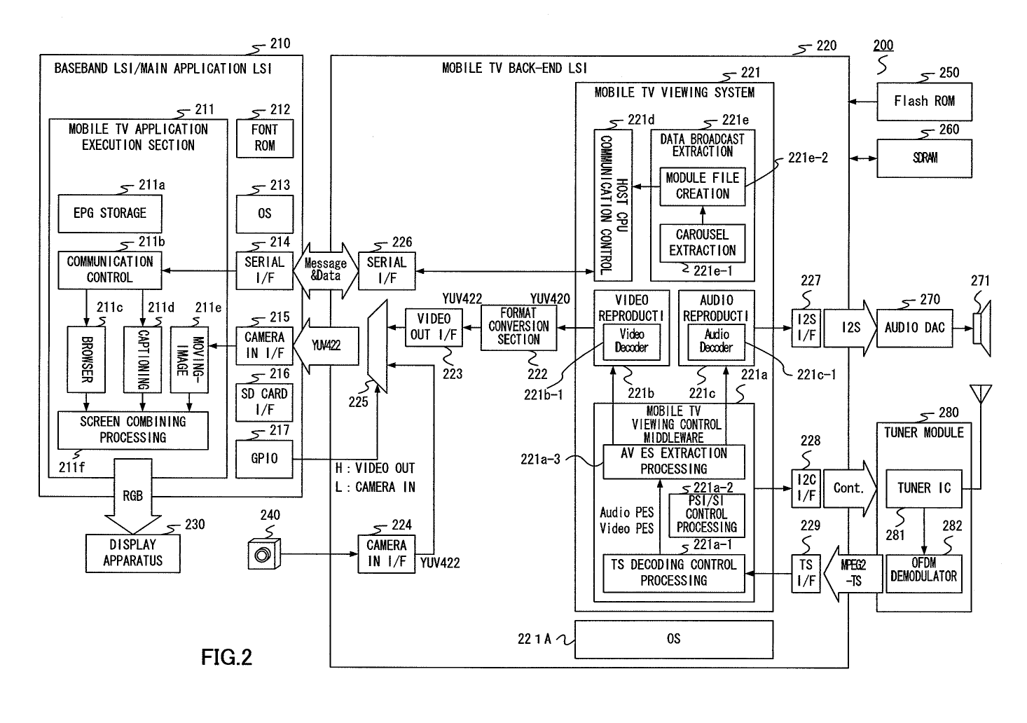

FIG. 2 is a block diagram showing the configuration of a mobile TV system incorporated in above-described portable terminal apparatus 100.

In FIG. 2, a mobile TV system 200 is configured by means of a baseband LSI/main application LSI 210, a mobile TV back-end LSI 220, a display apparatus 230, a camera 240, flash ROM 250, SDRAM 260, an audio DAC 270, a speaker 271, and a tuner module 280 comprising a tuner IC 281 and an OFDM (Orthogonal Frequency Division Multiplexing) demodulator 282.

Baseband LSI/main application LSI 210 corresponds to cellular baseband LSI 110 in FIG. 1, and mobile TV back-end LSI 220 corresponds to mobile TV back-end processing LSI 120 in FIG. 1. Also, display apparatus 230 corresponds to display apparatus 113 in FIG. 1, camera 240 to mobile phone camera module 125 in FIG. 1, and tuner module 280 to cellular RF module 115 in FIG. 1.

Baseband LSI/main application LSI 210 is configured by means of a mobile TV application execution section 211, font ROM 212, an OS (Operating System) 213, a serial I/F 214, a camera In I/F 215, an SD card I/F 216, and a GPIO (General Port Input Output) 217.

Mobile TV application execution section 211 executes image combining processing using font ROM 212 based on data input from serial I/F 214 and camera In I/F 215 in OS 213. Image combining processing data is output in RGB form, and displayed by display apparatus 230. Mobile TV application execution section 211 performs the following processing: EPG (Electronic Program Guide) storage 211a, communication control 211b, browser processing 211c, captioning 211d, moving-image processing 211e, and screen combining processing 211f.

GPIO 217 is an I/O used as a general-purpose input/output terminal at the time of system application. GPIO 217 output is a switching control signal for a selection circuit 225 of mobile TV back-end LSI 220.

Mobile TV back-end LSI 220 is configured by means of a mobile TV viewing system 221 and OS 221A, a format conversion section 222, a video Out I/F 223, a camera In I/F 224, a selection circuit 225, a serial I/F 226, an I2S (Inter IC Sound Interface) I/F 227, an I2C (Inter IC Controller) I/F 228, and a TS (Transport Stream) I/F 229. In mobile TV viewing system 221, a CPU 310 executes controls for mobile TV viewing in OS 221A—that is, mobile TV viewing control middleware 221a, video reproduction 221b, and audio reproduction 221c in the video system—and also executes host CPU communication control 221d and data broadcast extraction 221e in the communication system.

Specifically, mobile TV viewing control middleware 221a executes TS decoding control processing 221a-1, PSI/SI control processing 221a-2, and AV ES extraction processing 221a-3, and passes AV ES extraction processing results to video reproduction 221b and audio reproduction 221c. Video reproduction 221b reproduces video data by means of a video decoder 221b-1, and outputs that data to format conversion section 222. Audio reproduction 221c reproduces audio data by means of an audio decoder 221c-1, and outputs that data to I2S I/F 227.

On the other hand, data broadcast extraction 221e extracts carousel data from a TS contained in transmission control information by means of carousel extraction processing 221e-l, creates a module file by means of module file creation processing 221e-2, and passes this file to host CPU communication control 221d. Host CPU communication control 221d performs data input/output from/to serial I/F 226 using the module file.

Format conversion section 222 converts YUV420 format video playback output to YUV422 format output.

Video Out I/F 223 outputs a YUV422 format video signal.

Camera In I/F 224 converts video data captured by camera 240 to YUV format video data, and inputs this to one terminal of selection circuit 225.

Selection circuit 225 selects video Out I/F 223 output or camera 240 input based on GPIO 217 output, and outputs the selected signal to camera In I/F 215. Selection circuit 225 selects video output when GPIO 217 output is “H”, and selects camera input when GPIO 217 output is “L”. In the case of conventional technology, there is no selection section corresponding to selection circuit 225, and camera 240 output is input directly to baseband LSI/main application LSI 210.

I2S I/F 227 outputs audio data. I2C I/F 228 provides an interface to an external video encoder and decoder. TS I/F 229 is used for MPEG2-TS input.

Flash ROM 250 and SDRAM 260 comprise nonvolatile memory such as batch-read/write flash ROM or SRAM, and are used for data reading and data writing from/to mobile TV back-end LSI 220. Flash ROM 250 and SDRAM 260 are card-type storage media that can be inserted into and removed from the body of portable terminal apparatus 100.

Audio DAC 270 performs conversion and amplification of I2S data from I2S I/F 227 to an analog signal, and outputs this signal by means of speaker 271.

Tuner module 280 is controlled by a control signal from I2C I/F 228 of mobile TV viewing control middleware 221a. In tuner module 280, after an RF band frequency signal received by a receiving antenna is amplified by an LNA (Low Noise Amplifier) (not shown) and frequency-converted to a baseband frequency signal by means of tuner IC 281, a received signal of each subcarrier is obtained by OFDM demodulator 282 by execution of fast Fourier transform processing on the input signal. The per-subcarrier received signals have data distortion corrected by an equalizer, and become an OFDM demodulated signal. The demodulated MPEG2-TS is output to TS I/F 229, and TS I/F 229 passes the input MPEG2-TS to TS decoding control processing 221a-1.

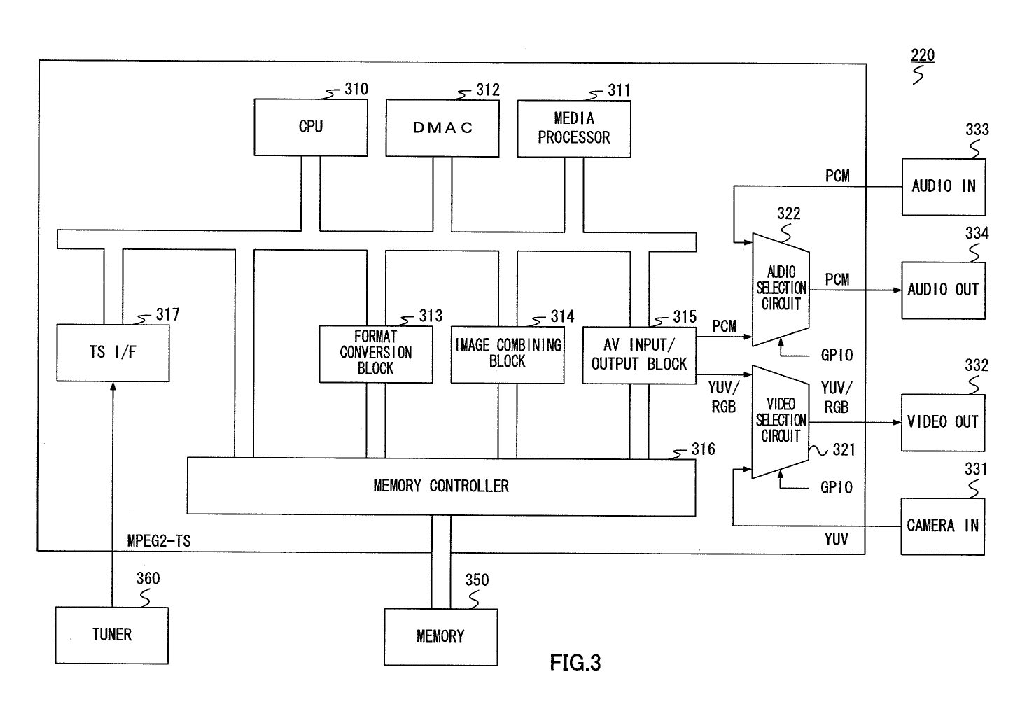

FIG. 3 is a block diagram showing the configuration of above-described mobile TV back-end LSI 220. FIG. 3 shows mobile TV back-end LSI 220 shown in FIG. 2 as a hardware configuration, and also shows the principal parts thereof.

In FIG. 3, mobile TV back-end LSI 220 is configured by means of a CPU 310, media processor 311, DMAC (Direct Memory Access Controller) 312, format conversion block 313, image combining block 314, AV input/output block 315, memory controller 316, TS I/F 317, internal bus 318, video selection circuit 321, audio selection circuit 322, memory 350, and tuner 360.

CPU 310 executes mobile TV viewing control middleware, and is also responsible for input/output device control, data broadcast processing, and TS decoding processing.

Media processor 311 is a processor featuring high signal processing and real-time processing performance that performs dedicated execution of high-speed digital processing of video, music, and so forth, such as video playback/audio playback.

DMAC 312 performs DMA control for transferring data directly between various apparatuses and internal memory through internal bus 318 without the intermediation of CPU 310. When a DMA request is issued, DMAC 312 issues an internal bus 318 release request to CPU 310, and if CPU 310 can release internal bus 318, outputs a bus use enabling signal and places the bus in the high-impedance state.

Format conversion block 313 performs RGB→YUV conversion/YUV→RGB conversion processing. Also, format conversion block 313 adjusts to the video output format.

Image combining block 314 combines camera images, video decoded images, and caption screens, and also executes image rotation and so forth.

AV input/output block 315 performs audio input/output I/F and video input/output I/F control.

Memory controller 316 controls work memory and frame buffer memory accesses.

TS I/F 317 is used for MPEG2-TS input from tuner 360.

Video selection circuit 321 performs output selection between camera input 331 and video decoding output 332. Audio selection circuit 322 performs output selection between audio input 333 and audio decoding output 334. For both video selection circuit 321 and audio selection circuit 322, either a selection register method or a terminal selection method is assumed for selection determination. Video selection circuit 321 and audio selection circuit 322 correspond to selection circuit 122 and selection circuit 123 in FIG. 1, and video selection circuit 321 also corresponds to selection circuit 225 in FIG. 2.

Memory 350 includes flash ROM 250 and SDRAM 260 in FIG. 2 as well as RAM 132 in FIG. 1.

Here, tuner 360 is tuner module 280 in FIG. 2.

The operation of a portable terminal apparatus configured as described above will now be explained.

Camera I/F 142 provided in cellular baseband LSI 110 is basically identical to camera I/F 152 connected to mobile phone camera module 125. Heretofore, a mobile phone camera module 125 video signal has been connected directly to camera I/F 142. In this embodiment, portable terminal apparatus 100 is newly equipped with mobile TV back-end processing LSI 120 that implements a mobile TV function, and it is necessary for mobile TV back-end processing LSI 120 to output a mobile TV video signal and audio signal to cellular baseband LSI 110. However, from the standpoints of achieving versatility, avoiding a cost increase, and reducing the circuit area of cellular baseband LSI 110, it is undesirable for a dedicated I/F for mobile TV video input to be provided in cellular baseband LSI 110. Thus, camera I/F 142 already provided in cellular baseband LSI 110 for camera-equipped mobile phone use is also made to serve as an I/F for mobile TV video signal input from mobile TV back-end processing LSI 120. Therefore, selection circuit 122 that selects a mobile phone camera module 125 video signal or a mobile TV video signal based on a control signal from cellular baseband LSI 110 is provided in mobile TV back-end processing LSI 120, and it is possible for a mobile digital TV function to be implemented by an application LSI not equipped with a dedicated mobile digital TV interface by outputting one or other of these video signals to camera I/F 142.

As shown in FIG. 1, portable terminal apparatus 100 is equipped with cellular baseband LSI 110 having a mobile phone call function and basic application functions such as AV processing, and mobile TV back-end processing LSI 120 having a mobile TV reception function, and cellular baseband LSI 110 and mobile TV back-end processing LSI 120 are interconnected by host I/F 141.

Front-end module 124, mobile phone camera module 125, and audio codec 126 are connected to mobile TV back-end processing LSI 120.

Front-end module 124 outputs MPEG2-TS format bit-stream data to back-end processing block 121 of mobile TV back-end processing LSI 120 via dedicated I/F 151. An MPEG2-TS format bit stream input to mobile TV back-end processing LSI 120 undergoes AV separation and decoding by back-end processing block 121, and video signal 161 and audio signal 162 are output.

Mobile phone camera module 125 outputs a video signal to mobile TV back-end processing LSI 120 via camera I/F 152, and microphone 127 audio data is converted to a digital signal by audio codec 126 and output to mobile TV back-end processing LSI 120 via a digital audio I/F.

A feature of mobile TV back-end processing LSI 120 of this embodiment is the provision of selection circuit 122 that selects a mobile TV reception function or camera input, and selection circuit 123 that selects a mobile TV reception function or microphone input.

Selection circuit 122 and selection circuit 123 perform switching operations in accordance with a control signal from cellular baseband LSI 110. Selection circuit 122 selects video signal 161 output from back-end processing block 121 or video signal 171 input from camera I/F 152, while selection circuit 123 selects audio signal 162 output from back-end processing block 121 or audio signal 172 input from audio codec 126. A control signal from cellular baseband LSI 110 is actually the GPIO output shown in FIG. 2 and FIG. 3. Mobile TV back-end LSI 220 (FIG. 2 and FIG. 3) corresponding to cellular baseband LSI 110 can send a control signal to an external destination using the GPIO when the camera function or a basic application function such as AV processing is executed.

Thus, a pair of AV digital signals comprising mobile TV video signal 161 and audio signal 162 output from back-end processing block 121, or video signal 171 and audio signal 172 output from camera I/F 152 and audio codec 126, are selected by selection circuit 122 and selection circuit 123 provided in mobile TV back-end processing LSI 120. The pair of AV digital signals selected by selection circuit 122 and selection circuit 123 are input to cellular baseband LSI 110 via camera I/F 142 and audio I/F 143 provided in cellular baseband LSI 110, and cellular baseband LSI 110 outputs the video signal and audio signal input to camera I/F 142 and audio I/F143 to display apparatus 113 and audio output apparatus 114 respectively.

The selection of a mobile TV reception function or camera input will now be described in detail with reference to FIG. 2 and FIG. 3.

Selection circuit 122 of mobile TV back-end processing LSI 120 in FIG. 1 corresponds to selection circuit 225 of mobile TV back-end LSI 220 in FIG. 1. Selection circuit 225 selects video Out I/F 223 output or camera 240 input based on baseband LSI/main application LSI 210 GPIO 217 output, and outputs the selected YUV422 format video signal to camera In I/F 215 of baseband LSI/main application LSI 210. Here, selection is determined by a terminal selection method using the GPIO. For example, selection circuit 225 selects video output when GPIO 217 output is “H”, and camera input when GPIO 217 output is “L”.

To consider the process in greater detail, selection circuit 122 and selection circuit 123 of mobile TV back-end processing LSI 120 in FIG. 1 correspond to video selection circuit 321 and audio selection circuit 322 of mobile TV back-end LSI 220 in FIG. 3. Video selection circuit 321 selects either AV input/output block 315 video output YUV/RGB or camera In input 331 based on baseband LSI/main application LSI 210 GPIO output, and outputs the selected YUV format RGB video signal to video Out output 332 of baseband LSI/main application LSI 210. Also, audio selection circuit 322 selects either AV input/output block 315 audio output PCM or audio In input 333 based on baseband LSI/main application LSI 210 GPIO output, and outputs the selected PCM audio signal to audio Out output 334 of baseband LSI/main application LSI 210.

As described above, according to this embodiment, there are provided a cellular baseband LSI 110 that performs overall portable terminal apparatus 100 control and is connected to a mobile TV back-end processing LSI 120 by a host I/F 141, camera I/F 142, and audio I/F 143, and a mobile TV back-end processing LSI 120 that implements a mobile TV function, a selection circuit 122 that selects a mobile phone camera module 125 video signal or mobile TV video signal based on a control signal from cellular baseband LSI 110 is provided in mobile TV back-end processing LSI 120, and one or other video signal is output to camera I/F 142, enabling existing camera I/F 142 that inputs a video signal from mobile phone camera module 125 also to be used as a mobile TV viewing video signal input I/F. By this means, it is possible to achieve versatility of cellular baseband LSI 110 while avoiding a cost increase and reducing the circuit area, and a mobile digital TV function can be implemented by an application LSI not equipped with a dedicated mobile digital TV interface.

Also, since versatility of cellular baseband LSI 110 is achieved, it is no longer necessary for a terminal manufacturer to independently create software that implements mobile TV viewing and recording functions, and a terminal equipped with a mobile digital TV function can be developed easily.

In this embodiment, a terminal selection method based on GPIO output (H/L) from cellular baseband LSI 110 as a control signal controlling selection circuits 122 and 123, and so forth, has been employed, but a selection register method may also be employed whereby a control code is transferred to a register and the output path is controlled by the value of that register, and the same kind of effects can be obtained with this method.

Also, an advantage of this embodiment is that a separate apparatus is not necessary in the main body of a camera-equipped mobile phone, and therefore immediate implementation is possible without design modifications or the addition of members to the main body.

### Embodiment 2

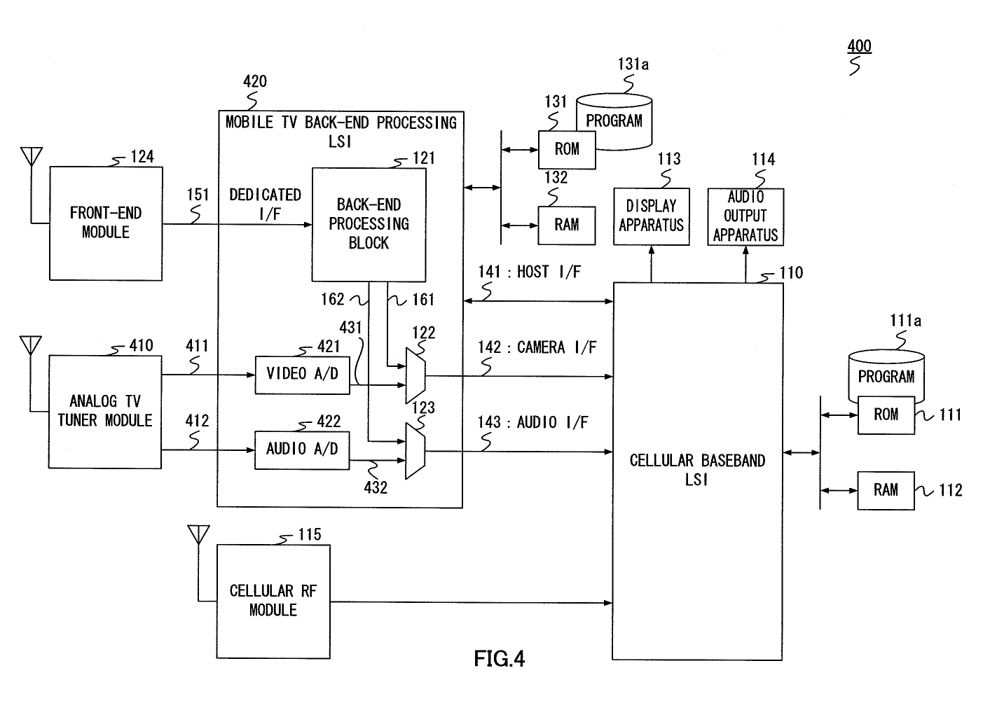

FIG. 4 is a block diagram showing the general configuration of a portable terminal apparatus of Embodiment 2 of the present invention. A portable terminal apparatus of this embodiment is an example in which a mobile TV system is applied to a camera-equipped mobile phone/PHS. Configuration parts identical to those in FIG. 1 are assigned the same reference codes as in FIG. 1, and duplicate descriptions are omitted.

In FIG. 4, a portable terminal apparatus 400 is configured by means of a cellular baseband LSI 110, ROM 111 that has a control program 111a, RAM 112, a display apparatus 113, an audio output apparatus 114, a cellular RF module 115, an analog TV tuner module 410, a mobile TV back-end processing LSI 420, a back-end processing block 121, selection circuits 122 and 123, a video A/D converter 421, an audio A/D converter 422, a front-end module 124, ROM 131 that has a control program 131a, RAM 132, a host I/F 141, a camera I/F 142, an audio I/F 143, and a dedicated I/F 151.

Portable terminal apparatus 400 has analog TV tuner module 410 instead of mobile phone camera module 125 and audio codec 126 in FIG. 1.

Mobile TV back-end processing LSI 420 includes back-end processing block 121, selection circuits 122 and 123, video A/D converter 421, and audio A/D converter 422, and executes mobile TV reception front-end processing.

Analog TV tuner module 410 receives analog TV broadcasts. An analog video signal 411 and analog audio signal 412 received by analog TV tuner module 410 are input to mobile TV back-end processing LSI 420, and are converted to digital signals by video A/D converter 421 and audio A/D converter 422, and post-digital-conversion video signal 431 and audio signal 432 are input to selection circuit 122 and selection circuit 123 respectively.

Selection circuit 122 and selection circuit 123 perform switching operations in accordance with a control signal from cellular baseband LSI 110. Selection circuit 122 selects video signal 161 output from back-end processing block 121 or video signal 431 converted to a digital signal input from analog TV tuner module 410, while selection circuit 123 selects audio signal 162 output from back-end processing block 121 or audio signal 432 converted to a digital signal input from analog TV tuner module 410.

Thus, according to this embodiment, host I/F 141 already provided in cellular baseband LSI 110 for camera-equipped mobile phone use is also used as an I/F for mobile TV video signal input from mobile TV back-end processing LSI 420. Therefore, by providing in mobile TV back-end processing LSI 120 a selection circuit 122 that selects an analog TV tuner module 410 video signal or mobile TV video signal based on a control signal from cellular baseband LSI 110, and outputting one or other video signal to camera I/F 142, it is possible to select either digital TV or analog TV, which ever has better sensitivity, and the reception area can be enlarged.

### Embodiment 3

In Embodiments 1 and 2, examples of application to a basic mobile-TV-equipped mobile phone have been described. In Embodiment 3, a description will be given of a portable terminal apparatus such as a surveillance camera apparatus that combines a plurality of camera images and outputs a single image.

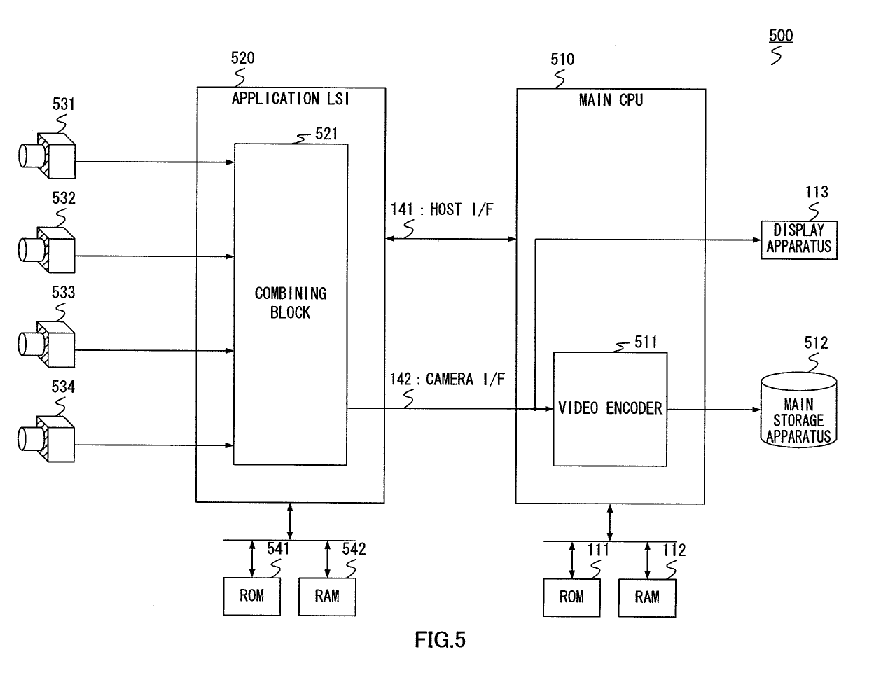

FIG. 5 is a block diagram showing the general configuration of a portable terminal apparatus of Embodiment 3 of the present invention. Configuration parts identical to those in FIG. 1 are assigned the same reference codes as in FIG. 1, and duplicate descriptions are omitted. This embodiment is an example of application to a camera imaging system that implements a surveillance camera function.

In FIG. 5, a camera imaging system 500 is configured by means of a main CPU 510, a video encoder 511, ROM 111, RAM 112, a display apparatus 113, a main storage apparatus 512, an application LSI 520, a combining block 521, camera modules 531 through 534, ROM 541, RAM 542, a host I/F 141, and a camera I/F 142.

Main CPU 510 performs overall control of camera imaging system 500, and is also connected to application LSI 520 by host I/F 141, which is a command transmission/reception interface, and camera I/F 142, which transmits combined images, and inputs a video signal from combining block 521 of application LS 1520 to existing camera I/F 142.

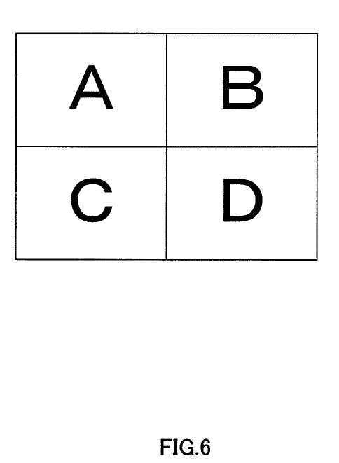

FIG. 6 is a drawing showing an example of combining of camera video inputs by combining block 521.

Combining block 521 combines a plurality of camera images. Here, as shown in FIG. 6, camera video inputs A through D output from camera modules 531 through 534 are combined, and a single image is output.

Video encoder 511 performs video encoding of a video signal input from application LSI 520 camera I/F 142 into a format that can be stored in main storage apparatus 512. This video encoding includes data compression processing.

Main storage apparatus 512 comprises an HDD, for example, and stores video-encoded video data.

According to this embodiment, a video signal from combining block 521 of application LSI 520 is input via camera I/F 142 of main CPU 510. Camera I/F 142 already provided in main CPU 510 is also used as an I/F for video signal input from application LSI 520. Therefore, it is possible to achieve versatility of main CPU 510 while avoiding a cost increase and reducing the circuit area.

In this embodiment an example has been described in which four cameras are connected to a surveillance camera system, but any number of cameras from two up may be used.

### Embodiment 4

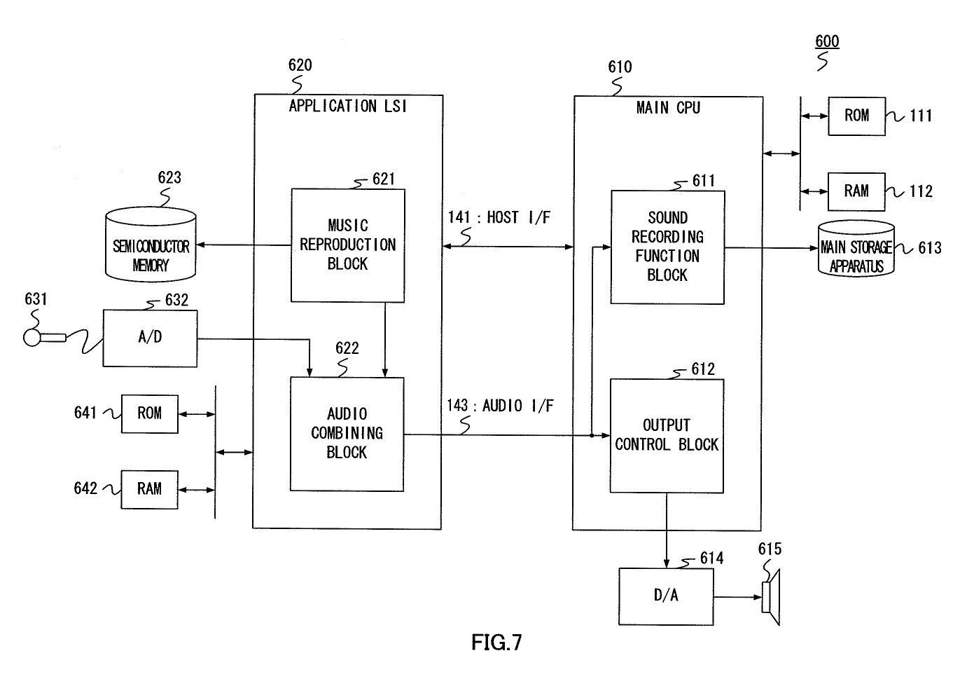

FIG. 7 is a block diagram showing the general configuration of a portable terminal apparatus of Embodiment 4 of the present invention. Configuration parts identical to those in FIG. 1 are assigned the same reference codes as in FIG. 1, and duplicate descriptions are omitted. This embodiment is an example of application to a mobile device system that combines voice from a microphone with music playback.

In FIG. 7, a mobile device system 600 is configured by means of a main CPU 610, a sound recording function block 611, an output control block 612, a main storage apparatus 613, a D/A converter 614, a speaker 615, ROM 111, RAM 112, an application LSI 620, a music reproduction block 621, an audio combining block 622, semiconductor memory 623, a microphone 631, an A/D converter 632, ROM 641, RAM 642, a host I/F 141, and an audio I/F 143.

Main CPU 610 performs overall control of mobile device system 600, and is also connected to application LSI 620 by host I/F 141, which is a command transmission/reception interface, and audio I/F 143, which transmits an audio signal, and inputs an audio signal from audio combining block 622 of application LSI 620 to existing audio I/F 143.

Music reproduction block 621 reproduces music. Music reproduction block 621 stores music reproduced together with application LSI 620 application execution in semiconductor memory 623, and also outputs this music to audio combining block 622.

Audio combining block 622 combines an audio (voice) signal from microphone 631 with an audio signal from music reproduction block 621. The combined audio signal is output to sound recording function block 611 and output control block 612 of main CPU 610 via audio I/F 143.

Sound recording function block 611 encodes an audio signal input from application LSI 620 via audio I/F 143 into a format that can be stored in main storage apparatus 613, and stores the encoded signal. This encoding includes data compression processing.

Main storage apparatus 613 comprises an HDD, for example, and stores encoded audio data.

Output control block 612 outputs an audio signal input via audio I/F 143 to D/A converter 614, and broadcasts it from speaker 615.

According to this embodiment, an audio signal from audio combining block 622 of application LSI 620 is input via audio I/F 143 of main CPU 610. Audio I/F 143 already provided in main CPU 610 is also used as an I/F for audio signal input from application LSI 620. Therefore, it is possible to achieve versatility of main CPU 610 while avoiding a cost increase and reducing the circuit area.

### Embodiment 5

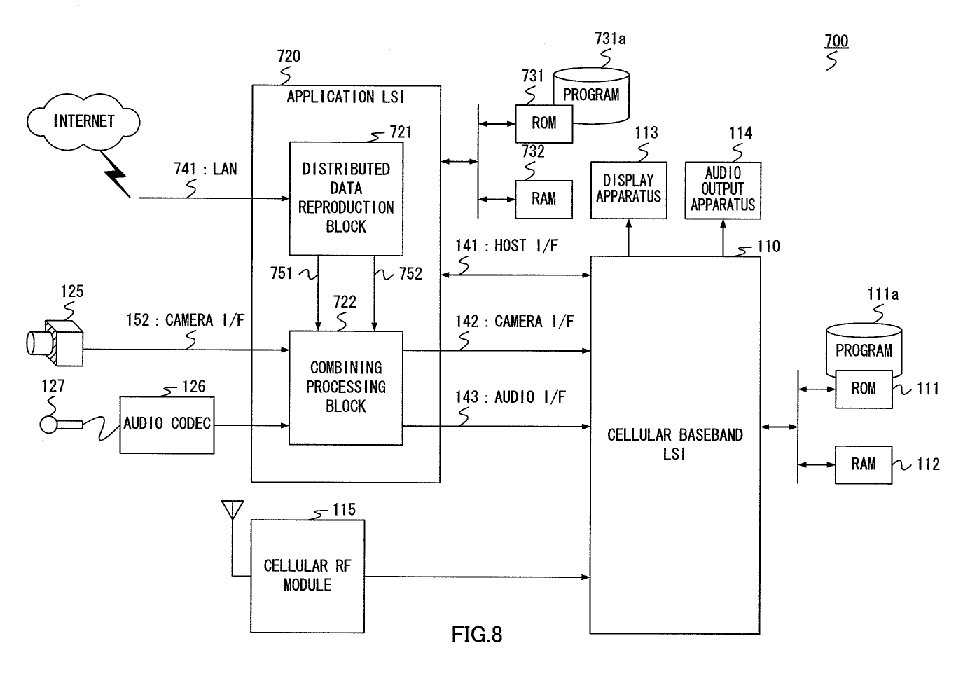

FIG. 8 is a block diagram showing the general configuration of a portable terminal apparatus of Embodiment 5 of the present invention. Configuration parts identical to those in FIG. 1 are assigned the same reference codes as in FIG. 1, and duplicate descriptions are omitted. This embodiment is an example of application to a mobile-TV-equipped mobile phone that combines a moving-image file stored in memory such as an SD card with mobile TV video.

In FIG. 8, a portable terminal apparatus 700 is configured by means of a cellular baseband LSI 110, ROM 111 that has a control program 111a, RAM 112, a display apparatus 113, an audio output apparatus 114, a cellular RF module 115, an application LSI 720, a distributed data reproduction block 721, a combining processing block 722, a mobile phone camera module 125, an audio codec 126, a microphone 127, ROM 731 that has a control program 731a, RAM 732, a host I/F 141, camera I/Fs 142 and 152, an audio I/F 143, and a LAN connection I/F 741.

Cellular baseband LSI 110 is connected to application LSI 720 by host I/F 141, camera I/F 142, and audio I/F 143, and has a network distributed data reception function through combined use of camera I/F 142 that inputs a video signal from mobile phone camera module 125 as a video signal input I/F, and combined use of audio I/F 143 as an audio signal input I/F.

Distributed data reproduction block 721 reproduces network distributed data.

Combining processing block 722 combines a video signal from mobile phone camera module 125 and an audio signal from audio codec 126 with a video signal 751 and audio signal 752 from distributed data reproduction block 721. For example, combining processing block 722 combines a camera captured image with an image distributed from a network such as the Internet, and creates a display image. A combined audio signal is output to cellular baseband LSI 110 via camera I/F 142 and audio I/F 143.

According to this embodiment, a video signal and audio signal from combining processing block 722 of application LSI 720 are input via camera I/F 142 and audio I/F 143 of cellular baseband LSI 110. Camera I/F 142 and audio I/F 143 already provided in main cellular baseband LSI 110 are also used as I/Fs for video and audio signal input from application LSI 720. Therefore, this embodiment can be applied to a video teleconference system using IP telephony, and it is possible to achieve versatility of cellular baseband LSI 110 while avoiding a cost increase and reducing the circuit area.

### Embodiment 6

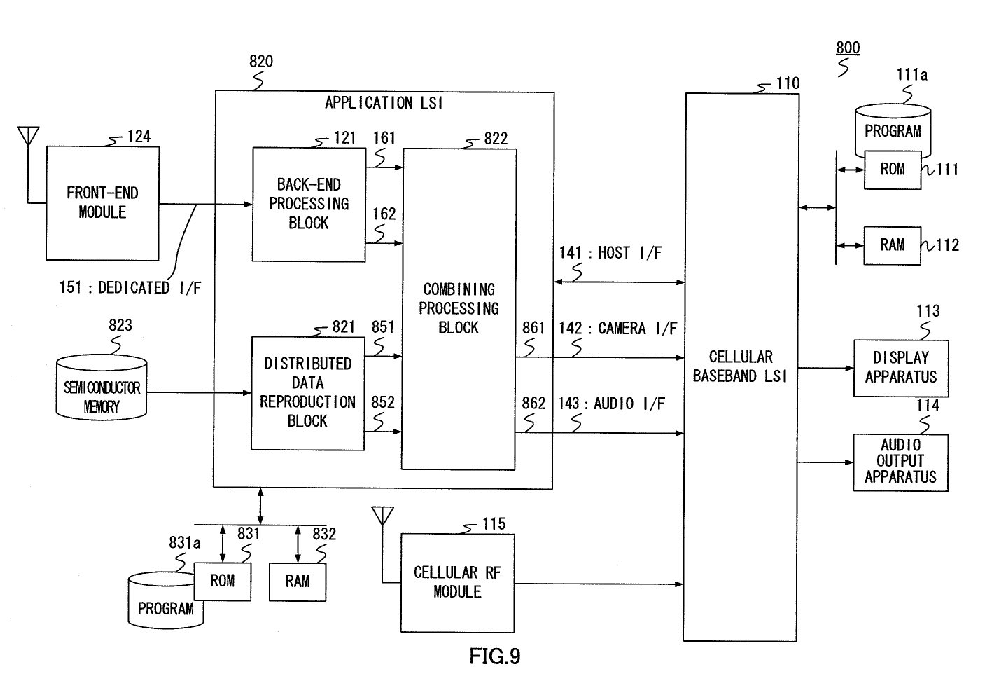

FIG. 9 is a block diagram showing the general configuration of a portable terminal apparatus of Embodiment 6 of the present invention. Configuration parts identical to those in FIG. 1 and FIG. 7 are assigned the same reference codes as in FIG. 1 and FIG. 7, and duplicate descriptions are omitted. This embodiment is an example of application to a mobile-TV-equipped mobile phone that combines a moving-image file stored in memory such as an SD card with mobile TV video.

In FIG. 9, a portable terminal apparatus 800 is configured by means of a cellular baseband LSI 110, ROM 111 that has a control program 111a, RAM 112, a display apparatus 113, an audio output apparatus 114, a cellular RF module 115, an application LSI 820, a back-end processing block 121, a distributed data reproduction block 821, a combining processing block 822, semiconductor memory 823, ROM 831 that has a control program 831a, RAM 832, a host I/F 141, a camera I/F 142, an audio I/F 143, and a dedicated I/F 151.

Cellular baseband LSI 110 is connected to application LSI 820 by host I/F 141, camera I/F 142, and audio I/F 143, and has a network distributed data reception function through combined use of camera I/F 142 that inputs a video signal from a mobile phone camera module (not shown) as a video signal input I/F, and combined use of audio I/F 143 as an audio signal input I/F.

Distributed data reproduction block 821 reproduces network distributed data.

Combining processing block 822 combines video signal 161 and audio signal 162 from back-end processing block 121 with a video signal 851 and audio signal 852 from distributed data reproduction block 821. For example, combining processing block 822 combines a moving-image file stored in semiconductor memory 823 such as an SD card with mobile TV video. A combined video signal 861 and audio signal 862 are output to cellular baseband LSI 110 via camera I/F 142 and audio I/F 143.

According to this embodiment, a video signal and audio signal from combining processing block 822 of application LSI 820 are input via camera I/F 142 and audio I/F 143 of cellular baseband LSI 110. Camera I/F 142 and audio I/F 143 already provided in main cellular baseband LSI 110 are also used as I/Fs for video and audio signal input from application LSI 820. Therefore, this embodiment can be applied to a mobile-TV-equipped mobile phone that combines a moving-image file stored in memory such as an SD card with mobile TV video, and it is possible to achieve versatility of cellular baseband LSI 110 while avoiding a cost increase and reducing the circuit area.

A mobile phone, portable terminal apparatus, camera imaging system, and mobile device system of the present invention are not limited to the above-described embodiments, and various variations and modifications may be possible without departing from the scope of the present invention.

For instance, examples of application to a mobile phone as a portable terminal apparatus have been described, but application of the present invention is not limited to a mobile phone, and it is also possible to apply the present invention to an apparatus having an information device function such as a PDA (Personal Digital Assistant) or an apparatus combining these. Application is possible to all systems, including an apparatus having a combined information device function such as a portable personal computer.

The type, setting information type and format, and so forth, of processing sections, etc., configuring an above-described portable terminal apparatus are not limited to those in the above embodiments.

In the above embodiments, the terms “mobile phone,” “portable terminal apparatus,” “camera imaging system,” and “mobile device system” have been used, but this is simply for convenience in describing the embodiments, and a term such as “image display apparatus” or the like may also be used.

An above-described portable terminal apparatus can also be implemented by a program that causes that portable terminal apparatus to function. This program is stored in/on a computer-readable recording medium.

As described above, according to the present invention already provided camera I/F 142 can also be used as a mobile TV viewing video signal I/F, versatility of cellular baseband LSI 110 can be achieved while avoiding a cost increase and reducing the circuit area, and a mobile digital TV function can be implemented by an application LSI not equipped with a dedicated mobile digital TV interface.

Also, it is no longer necessary for a terminal manufacturer to independently create software that implements mobile TV viewing and recording functions, and a terminal equipped with a mobile digital TV function can be developed easily.

Furthermore, a mobile TV viewing system having a TV viewing function can easily be added to a conventional mobile phone system.

Therefore, a portable terminal apparatus according to the present invention can be applied to a communication terminal apparatus such as a camera-equipped mobile phone. The present invention, by enabling shared used of a camera input interface provided as standard in an application LSI and baseband LSI installed in current mobile phone terminals and a mobile TV reception interface necessary for mobile TV viewing recently established as a full-fledged service, is useful in the application of a system provided with an apparatus and program that enable a mobile TV reception function to be added easily even to a main CPU that does not have a dedicated mobile TV interface. It is also possible for the present invention to be incorporated as a control program in an electronic device such as a mobile phone.

What is claimed is:

1. A portable terminal apparatus comprising:
an external specific function section that executes a specific program;
a host interface that controls said external specific function section;
a camera interface; and
a control section that performs control for selecting output from said external specific function section or input to said camera interface, and connecting that selected signal to said camera interface.

2. The portable terminal apparatus according to claim 1, wherein said camera interface inputs imaging data from a camera module.

3. The portable terminal apparatus according to claim 1, wherein said external specific function section is a mobile TV module that receives mobile TV.

4. The portable terminal apparatus according to claim 1, wherein said control section combines output from said external specific function section and input to said camera interface, and performs control for connecting that combined signal to said camera interface.

5. The portable terminal apparatus according to claim 1, wherein:
said external specific function section comprises:
a function-section-side camera interface with an identical function to said camera interface; and
a selection section that selects output from said external specific function section or input to said function-section-side camera interface, and
said external specific function section inputs a signal selected by said selection section to said camera interface.

6. The portable terminal apparatus according to claim 1, wherein:
said external specific function section comprises:
a function-section-side camera interface with an identical function to said camera interface; and
a combining section that combines output from said external specific function section with input to said function-section-side camera interface, and
said external specific function section inputs a signal combined by said combining section to said camera interface.
